(19) United States
(12) Patent Application Publication
(10) Pub. No.: US 2008/0248805 A1
(43) Pub. Date: Oct. 9, 2008

(54) Method and apparatus for subcell selection for assigning subcarrier in DAS OFDMA scheme

(75) Inventors: Shuangfeng Han, Suwon-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 12/080,995

(22) Filed: Apr. 7, 2008

(30) Foreign Application Priority Data
Apr. 6, 2007 (KR) 34376/2007

(51) Int. Cl. H04Q 7/20

(52) U.S. Cl. 455/450

(57) ABSTRACT

Disclosed is a method and an apparatus for assigning a subcarrier to a subcell serviced by a Distributed Antenna System (DAS) employing an Orthogonal Frequency Division Multiplexing Access (OFDMA) scheme in a broadband wireless access system. The method includes dividing an overall frequency band into multiple subcarrier bands, assigning the multiple subcarrier bands to respective Base Stations (BSs) without overlap among the BSs adjacent to one another in assigning the multiple subcarrier bands corresponding to the divided overall frequency band to the respective BSs and dividing the assigned subcarrier bands and selectively assigning the divided subcarrier bands to multiple Remote Stations (RSs) connected with the BSs through optical fibers.

### CLAIM OF PRIORITY

This application claims the benefit of the earlier filing date, under 35 U.S.C. §119(a), to that patent application entitled “Method and Apparatus for Subcell Selection for Assigning Subcarrier in DAS of OFDMA Scheme” filed in the Korean Intellectual Property Office on Apr. 6, 2007 and assigned Serial No. 2007-34376, the contents of which are hereby incorporated by reference.

### BACKGROUND OF THE INVENTION

1. Field of the Invention

The present invention relates to a cell selection in an Orthogonal Frequency Division Multiplexing Access (OFDMA) system, and more particularly relates to a method and an apparatus for subcell selection, which assigns subcarriers used for serving of a specific Subscriber Station (SS) within each subcell in the same cell to another SS, thereby minimizing the transmission power of an overall system.

2. Description of the Related Art

At present, with advances in communication industry and with an increase of the requirements of a user in relation to internet service, the need for a communication system that can efficiently offer internet service is increasing. The existing communication network has been developed for the main purpose of a voice service. This service has drawbacks in that it has a relatively narrow data transmission bandwidth, and needs a relatively expensive charge for its usage.

In order to settle such drawbacks, a study on a scheme of OFDM is being rapidly carried out as a representative example of a broadband wireless access scheme.

The scheme of OFDM corresponds to a typical transmission scheme employing multi-carriers that converts a symbol queue input in series into parallel data, modulates a converted symbol queue through multiple subcarriers having mutual orthogonality, and then transmits a modulated symbol queue. The above-mentioned scheme of OFDM can be widely applied to digital transmission technology that needs high-speed data transmission, such as wireless internet, Digital Audio Broadcasting (DAB) and digital television, Wireless Local Area Network (WLAN), and the like.

The scheme of OFDM (See L. J. Cimini, “Analysis and Simulation of a Digital Mobile Channel Using Orthogonal Frequency Division Multiplexing,” IEEE Trans. Commn., vol. COM-33, no. 7, pp. 665-675, June 1985; Richard Van Nee and Ramjee Prasad, “OFDM for Wireless Multimedia Communications,” Artech House, 2000) corresponds to multiplexing technology that subordinately divides a bandwidth into multiple frequency subcarriers.

In the OFDM, an input data stream is divided into several parallel substreams having a reduced data rate (therefore, the symbol length increases). Then, each substream is modulated, and is transmitted on a separated orthogonal subcarrier. An increase of the symbol length improves the robustness of the OFDM against delay diffusion. OFDM modulation can be realized by efficient Inverse Fast Fourier Transforms (IFFT), which in turn enables multiple subcarriers having low complexity.

In the above OFDM system, channel resources employ an OFDM symbol in the time domain, and is enabled by using subcarriers in the frequency domain. Time and frequency resources consist of subchannels assigned to an individual user.

Also, the scheme of OFDM corresponds to a scheme of multiaccess/multiplexing, provides a multiplexing operation relating to data streams from multiple users to Up Link (UL) multi-access employing a Down Link (DL) subchannel and an UL subchannel.

As previously described, the subcarrier is usually grouped into subsets called subchannels. For example, in a World interoperability for Microwave Access (WiMAX) system, the structure of OFDM symbol is made up of three types of subcarriers, including a data subcarrier for data transmission, a pilot subcarrier for an evaluation and synchronization, and a null subcarrier for a guard band and a DC carrier. An activated (data and pilot) subcarrier is grouped into subchannels.

A WiMAX OFDM physical layer (See IEEE 802.16-2004 (Revision of IEEE Std 802.16-2001), “IEEE Standard for Local and Metropolitan Area Networks—Part 16: Air Interface for Fixed Broadband Wireless Access Systems,” October 2004; IEEE 802.16e-2005, “IEEE Standard for Local and Metropolitan Area Networks—Part 16: Air Interface for Fixed and Mobile Broadband Wireless Access Systems,” February 2006) supports subchannelization both in a DL and in an UL, and a unit of the minimum frequency/time resources of the subchannel corresponds to one slot.

Hence, research on algorithms for assigning an adaptive subcarrier (subchannel) has been extensively carried out in a multi-user OFDM system. However, most of these algorithms are based on a Central Antenna based System (CAS).

On the other hand, an OFDM system based on a Distributed Antenna System (DAS) can allow a subcarrier to be used by another antenna.

In general, a DAS (see A. M. Adel, A. Saleh, A. J. Rustako, and R. S. Ramon, “Distributed Antennas for Indoor Radio Communications,” IEEE Trans. Commun., vol. 35, pp. 1245-1251, December 1987; S. Zhou, M. Xhao, X. Xu, J. Wang, and Y. Yao, “Distributed Wireless Communications System: a New Architecture for Future Public Wireless Access,” IEEE Commun. Mag., vol. 17, no. 3, pp. 108-113, March 2003) can provide macrodiversity that controls a large-scale fading and reduces an access distance by distributing antennas geometrically. The DAS, has been introduced so as to solve a coverage area problem in an indoor wireless system, and afterwards has been applied to the performance improvement of a Code Division Multiple Access (CDMA) system.

FIG. 1 is a view illustrating a coverage area associated with each distributed antenna leaving a Base Station (BS) centered in a DAS. With reference to FIG. 1, in the DAS, the antennas of the BS are uniformly distributed geometrically, and with each antenna of the BS as the center of a hexagon area, an overall area can be divided, in this illustrated case, into six hexagonal sub-areas. If an average access distance decreases in the DAS, as transmission power is reduced, inter-antenna interference diminishes, and capacity can increase. Channel conditions of the antennas of the BS are measured and analyzed by a subscriber station (SS) in each frame, and then an antenna M having the maximum gain can be selected as a serving antenna in the next frame. The value of M is equal to or greater than ‘1.’ Herein, the value of M is confined to being ‘1’ to have a positive value.

If the number of antennas equals ‘P’ within a cell of the DAS, the number of developed subcarriers becomes P times as many as a CAS. Thus, an assignment of resources is developed more complicated in the DAS.

At present, in the DAS based on the OFDMA, an algorithm for assigning subchannels can be classified into several types as.

1. Each antenna develops all subchannels.

2. All subchannels are assigned to cells only once. This implies that if any subchannel is used by one antenna in a cell, the subchannel cannot be employed even by any other antenna within the cell.

3. Each subchannel is assigned from a global viewpoint, and in order to obtain diversity gain, it is allowed for two adjacent antennas to use one SS through the same subchannel.

However, if each antenna develops all subchannels as described above, this is the same as cell division from a standpoint of frequency reuse, and incurs interantenna interference similar to co-channel interference in the cell division. Also, if all subchannels are developed by one remote antenna and one SS, even though interference is excluded from another antenna, this is a waste of bandwidth, and problems arise in hot-zones, for example.

Hence, at present, even though two antennas are sufficiently far away from each other in an OFDMA-based DAS, its subchannels cannot be reused.

### SUMMARY OF THE INVENTION

Accordingly, the present invention provides a method and an apparatus for subcell selection, which assigns subcarriers used for serving of a specific Subscriber Station (SS) within each subcell in the same cell to another SS, thereby minimizing the transmission power of an overall system.

In accordance with an aspect of the present invention, there is provided a method for selecting a subcell in order to assign a subcarrier by a Distributed Antenna System (DAS) employing an Orthogonal Frequency Division Multiplexing Access (OFDMA) scheme in a broadband wireless access system, including the steps of dividing an overall frequency band into multiple subcarrier bands, assigning the multiple subcarrier bands to respective Base Stations (BSs) without overlap among the BSs adjacent to one another in assigning the multiple subcarrier bands corresponding to the divided overall frequency band to the respective BSs; and dividing the assigned subcarrier bands and selectively assigning the divided subcarrier bands to multiple Remote Stations (RSs) connected with the BSs through optical fibers.

In accordance with another aspect of the present invention, there is provided an apparatus for selecting a subcell in order to assign a subcarrier by a Distributed Antenna System (DAS) employing an Orthogonal Frequency Division Multiplexing Access (OFDMA) scheme in a Base Station (BS) apparatus of a broadband wireless access system, including a first assigning unit for receiving the fading value of each multiple antennas located in the same cell, for arranging the received fading values in ascending order, and for selecting antennas in turn from an antenna having the minimum fading value among the fading values arranged in ascending order, a second assigning unit for comparing the transmission power value of the selected antenna with the preset maximum power and quality of a signal, respectively, and for selecting an antenna according to a result of comparison and a third assigning unit for finding the remaining subcarriers within adjacent subcells with a relevant subcell where the selected antenna is located or the relevant subcell as the center of the adjacent subcells, and for assigning the found remaining subcarriers in consideration of the total transmission power in a cell.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a view illustrating a coverage area of each distributed antenna leaving a Base Station (BS) centered in a general DAS;

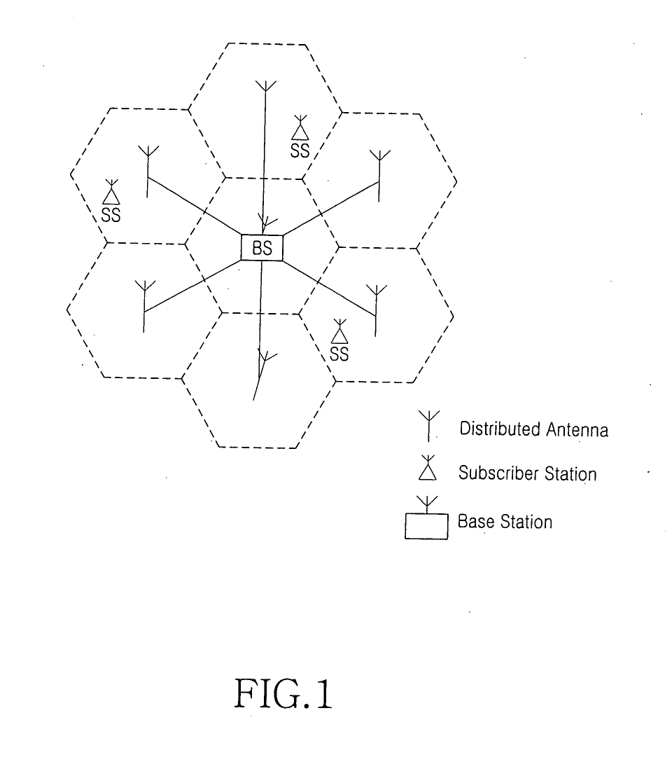

FIG. 2 is an overall configuration view illustrating an overall frequency band divided into three subcarrier bands assigned to seven subcells adjacent to one another in an OFDMA system according to an embodiment of the present invention;

FIG. 3 is a configuration block diagram illustrating a portion of an overall internal configuration of a BS in which the assignment of subcarriers is performed in an OFDMA system according to an embodiment of the present invention;

FIG. 4 is an overall configuration view illustrating the division of seven subcells adjacent to one another so that subcarrier bands may not be overlapped among the seven subcells in an OFDMA system according to an embodiment of the present invention; and

FIG. 5 is a flowchart illustrating a method for subcell selection for assigning subcarriers in an OFDMA system according to an embodiment of the present invention.

### DETAILED DESCRIPTION OF THE INVENTION

Exemplary embodiments of the present invention will be described in detail with reference to the accompanying drawings. The description includes particulars, such as specific configuration elements, that are provided to facilitate a more comprehensive understanding of the present invention, and it will be recognized to those of ordinary skill in the art that changes in form and modifications may be made to the particulars in the scope of the present invention.

Also, the method for assigning a subcarrier according to the present invention, can be applied to a general broadband wireless communication system using a multicarrier transmission scheme, and hereinafter, a description will be made to an embodiment applied to an OFDMA communication system as a representative example.

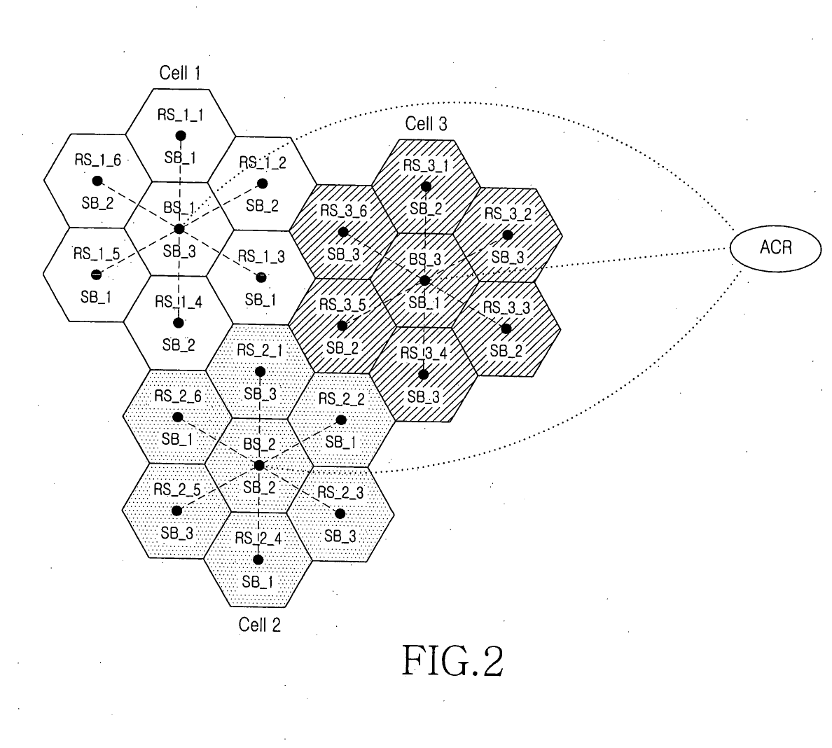

FIG. 2 is an overall configuration view illustrating an overall frequency band divided into three subcarrier bands assigned to seven subcells adjacent to one another in an OFDMA system according to an embodiment of the present invention. Referring to FIG. 2, an existing hexagonal cell centering each central BSs 1, 2, and 3 in the existing hexagonal cell is divided into seven hexagonal subcells adjacent to one another where each of the central BSs 1, 2, and 3 is positioned in the center of the divided cell, and the remaining subcells each of which has an antenna of a Remote Station (RS) located in its center lies around the BS subcell. Herein, an overall frequency band is divided into three non-overlapping Subcarrier Bands (SBs) corresponding to SB_1, SB_2, and SB_3, respectively. The SBs are assigned so that a single SB may be specified for each of three different subcells adjacent to one another.

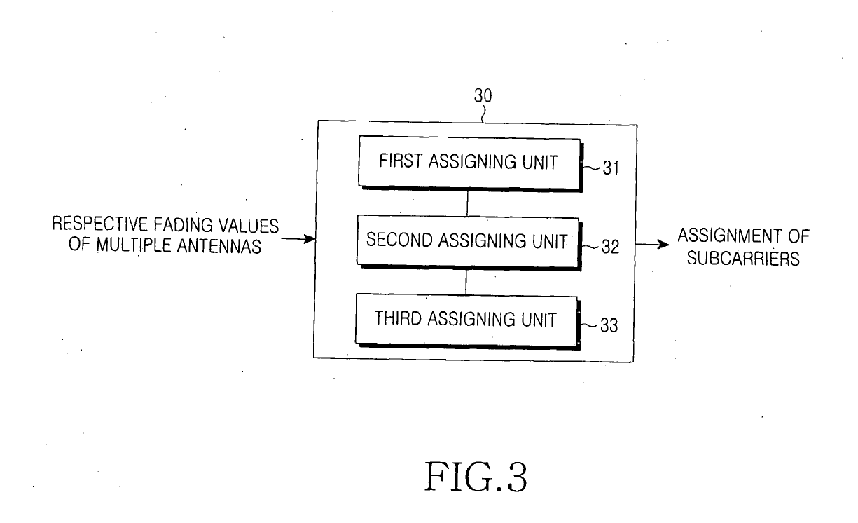

FIG. 3 is a configuration block diagram illustrating a part of an overall internal configuration of a BS in which the assignment of subcarriers is performed in an OFDMA system according to an embodiment of the present invention. With reference to FIG. 3, the fading values received through antennas of all RSs existing within a relevant cell are input to a subcarrier assigning apparatus 30 included in the BS at every preset assignment period. The subcarrier assigning apparatus 30 sequentially applies an assignment method according to the present invention at every assignment period (i.e., in a case where a specific SS obtains access) by using the fading value by antenna which has been input, and enables a first, second, and third assigning units 31, 32, and 33 to perform the adaptive type assignment of power and subcarriers.

More particularly, the subcarrier assigning apparatus 30 in the BS includes a first assigning unit, a second assigning unit, and a third assigning unit. Herein, the first assigning unit receives the fading value of each of multiple antennas located in the same cell, arranges the received fading values in ascending order, and assigns antennas from an antenna having a minimum fading value among the fading values arranged in ascending order. The second assigning unit compares the transmission power value of the assigned antenna with the preset maximum power and quality of a signal, respectively, and selects an antenna according to a result of the comparison. The third assigning unit finds the remaining subcarriers within adjacent subcells with a relevant subcell where the selected antenna is located or the relevant subcell as the center of the adjacent subcells, and assigns the found remaining subcarriers in consideration of the total transmission power in a cell.

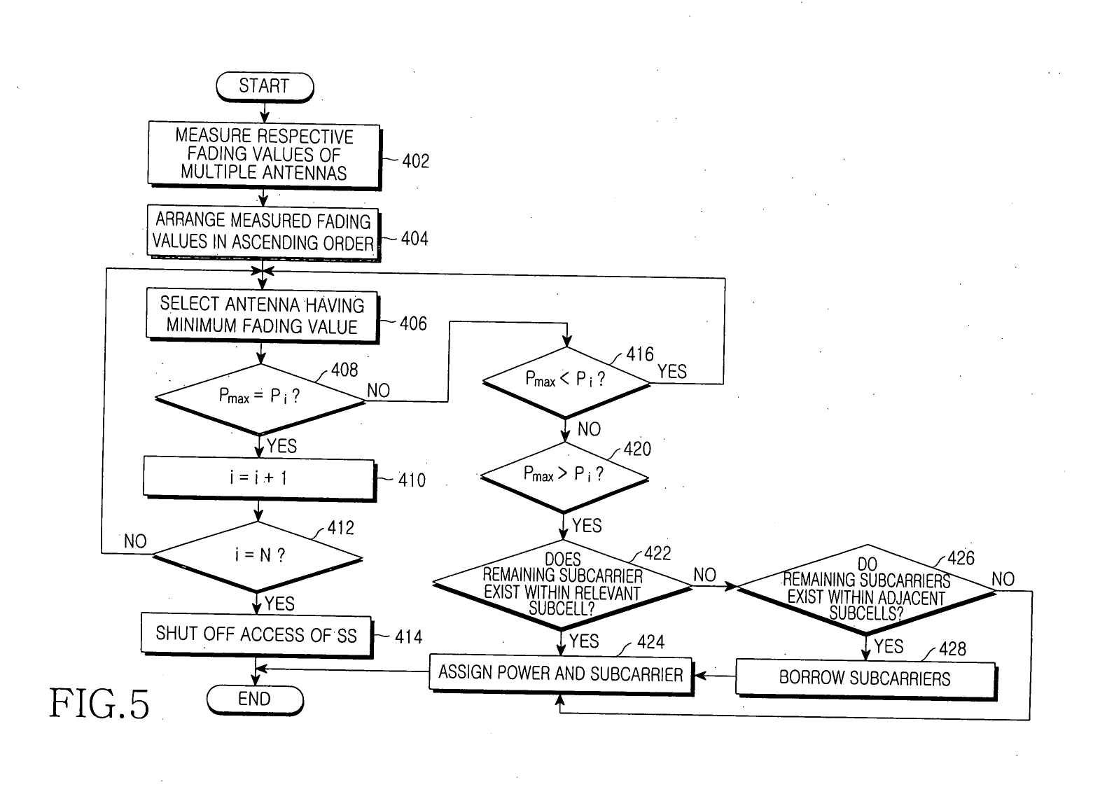

Although not illustrated in FIG. 3, the BS can be equipped with a receiving unit for receiving the fading value of each of the multiple antenna located in a relevant cell, and for providing the received fading value to the first, second, and third assigning units 31, 32, and 33. Because this can be implemented by using the well known art, a detailed description will be omitted. A method for assigning a subcarrier according to the present invention will be specifically described with reference to FIG. 5.

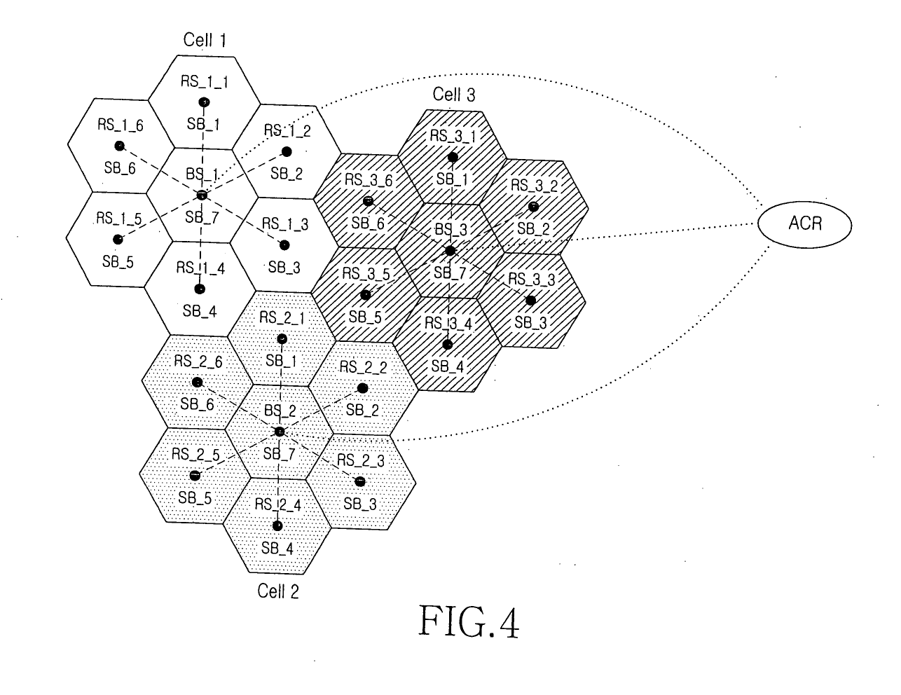

With reference to FIG. 4, an overall frequency band can be selectively divided into seven non-overlapping subcarrier bands corresponding to SB_1, SB_2, SB_3, SB_4, SB_5, SB_6, and SB_7, respectively. The SBs are assigned so that a single SB may be specified for each of seven subcells adjacent to one another. Because of the orthogonality of subcarriers respectively having different frequencies, there is no Down Link (DL) interference among different SSs in subcells adjacent to one another. Herein, the respective BSs 1, 2, and 3 are connected through optical fibers, and are controlled by an Access Control Router (ACR). RSs existing within each subcell are connected through optical fibers, and are controlled by a BS.

Meanwhile, handover of an SS within each subcell is performed by the BSs 1, 2, and 3, and on the other hand, handover of a specific SS between different cells is comprehensively controlled by an ACR and the BSs 1, 2, and 3.

When the specific SS enters a subcell, before the assignment of resources, an antenna of the BS or an antenna of the RS is first selected as a serving antenna. Because the specific SS is surrounded by a maximum of three subcells, the selection of an antenna produces a result of selection of a cell.

FIG. 5 is a flowchart illustrating a method for subcell selection for assigning subcarriers in an OFDMA system according to an embodiment of the present invention. In putting the present invention in practice, a specific SS can be permitted to obtain as many accesses as the number of antennas existing within a relevant cell in consideration of the total transmission power.

With reference to FIG. 5, a method by which a BS selects a serving antenna and a serving subcell required to assign a subcarrier to the specific SS by using Channel Status Information (CSI) received from the specific SS is disclosed. In step 402, the specific SS measures the respective fading values of multiple antennas existing within the relevant cell that the specific SS attempts to enter. Herein, the respective fading values (expressed in terms of dB) of a maximum of N antennas, i.e. L₁, L₂, . . . , L_{N} on the assumption that L₁<=L₂<= . . . <=L_{N}, are measured.

In relation to the above N number of candidate antennas, a search is made for a serving antenna (i.e., a serving subcell and cell). First, initialization is performed to set i=1 and A=A(Lᵢ), where A represents a selected subcell, and i means the number of times by which a process for selecting the specific SS attempting the entry and the serving antenna, i.e., a subcell in an area where the serving antenna is located is performed. Hence, if the process for selecting the specific SS and the subcell is completed, i is incremented by one, i.e. i=i+1.

In step 404, the measured fading values are arranged from the minimum fading value to the maximum fading value, i.e. in ascending order. In step 406, a relevant antenna Lᵢ having the minimum fading value is selected.

Then, the power and quality of a signal Pᵢ of the selected antenna is measured, and is compared with the power and quality of a signal Pₘₐₓ of a preset antenna in step 408. If it is determined in step 408 that Pᵢ is equal to the power and quality of a signal Pₘₐₓ of the preset antenna, since the process for selecting the subcell in relation to the specific SS has been performed, in step 410, i is incremented by one, i.e. “i=i+1.” In step 412, the number of times by which the process for selecting the subcell in relation to the specific SS is performed is compared with the total number of antennas positioned within the relevant subcell, i.e. “i=N ?.” If it is determined in step 412 that the number of times by which the process for selecting the subcell in relation to the specific SS is performed is equal to the total number of antennas, because the subcell cannot perform communications with another SS in addition to SSs with which the subcell is currently communicating, the relevant cell shuts off access of the specific SS. Next, the procedure returns back to step 406, and selects an antenna with the second rank of the minimum fading value. As described above, if Pᵢ of the antenna selected in relation to the specific SS attempting the entry is equal to the power and quality of a signal of the preset antenna. Pₘₐₓ, steps from 406 to 412 are repeatedly performed as long as i is less than N.

However, it is determined in step 408 that Pᵢ is not equal to the power and quality of a signal of the preset antenna Pₘₐₓ, i.e. if Pᵢ is greater than Pₘₐₓ (step 416), the procedure returns back to step 406 to select an antenna with the second rank of the minimum fading value, and performs subsequent steps.

Also, if it is determined in step in step 416 that Pᵢ is not greater than the power and quality of a signal of the preset antenna Pₘₐₓ, i.e. if Pᵢ is less than Pₘₐₓ (step 420), the procedure proceeds to step 422 to search for whether the remaining subcarrier exists within a relevant subcell where an antenna whose Pᵢ is less than Pₘₐₓ is positioned. If it is determined in step 422 that the remaining subcarrier exists within the relevant subcell, the remaining carrier is assigned to the specific SS attempting access in step 424. In step 424, the remaining subcarrier of an adjacent cell is assigned to the specific SS within the relevant subcell.

Furthermore, if it is determined in step 422 that no remaining subcarrier exists within the relevant subcell, the procedure proceeds to step 426 to search for whether remaining subcarriers exist within adjacent subcells. If it is determined in step 426 that the remaining subcarriers exist within the adjacent subcells, the procedure proceeds to step 428 to borrow the remaining subcarriers. However, if it is determined in step 426 that no remaining subcarriers exist within the adjacent subcells, the procedure goes to step 424 to perform the assignment of power and subcarriers so as to minimize transmission power of an overall system.

The merits and effects of exemplary embodiments, as disclosed in the present invention, and as so configured to operate above, will be described as follows.

According to the present invention, by assigning some of subcarriers used for serving of a specific SS within each subcell in the same cell to another SS, the transmission power of an overall system is minimized.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to certain exemplary embodiments thereof, it will be understood by those skilled in the art that various changes in form and details may be made therein without departing from the spirit and scope of the invention. Therefore, the spirit and scope of the present invention must be defined not by described embodiments thereof but by the appended claims and equivalents of the appended claims.

What is claimed is:

1. A method for assigning a subcarrier in a subcell serviced by a Distributed Antenna System (DAS) employing an Orthogonal Frequency Division Multiplexing Access (OFDMA) scheme in a broadband wireless access system, the method comprising:
dividing an overall frequency band into multiple subcarrier bands;
assigning the multiple subcarrier bands to respective Base Stations (BSs) without overlapping among the BSs adjacent to one another in assigning the multiple subcarrier bands to the respective BSs; and
dividing the assigned subcarrier bands and selectively assigning the divided subcarrier bands to multiple Remote Stations (RSs) connected with the BSs.

2. The method as claimed in claim 1, further comprising:
measuring a respective fading values of multiple antennas located in the same cell, and assigning the measured fading values in ascending order;
selecting an antenna in an order from a minimum fading value among fading values assigned in ascending order;
comparing the transmission power value of the selected antenna and the preset maximum power and quality of a signal, and determining if an antenna is selected according to a result of the comparison;
finding the remaining subcarriers within adjacent subcells with a relevant subcell where the selected antenna is located or the relevant subcell as the center of the adjacent subcells; and
assigning the found subcarriers in consideration of the total transmission power within the same cell where the subcell is located.

3. The method as claimed in claim 2, further comprising:
shutting off a specific Subscriber Station (SS) attempting access in a case where a comparison is made between the number of times by which the selection of the antenna having the minimum fading value is performed and the total number of antennas within the relevant cell, and the number of times is equal to the total number of antennas.

4. The method as claimed in claim 2, further comprising:
selecting an antenna having the second rank of the minimum fading value except for the selected antenna if the selected antenna has the preset maximum power and quality of a signal.

5. The method as claimed in claim 2, further comprising:
selecting an antenna having the second rank of the minimum fading value except for the selected antenna if the selected antenna has the power and quality of a signal that is greater than the preset maximum power and quality of a signal.

6. The method as claimed in claim 2, further comprising:
finding the remaining subcarrier within a subcell of an area where the relevant antenna is located if the selected antenna has the power and quality of a signal that is less than the preset maximum power and quality of a signal; and
assigning power and a subcarrier in consideration of the total transmission power within the same cell where the subcell is located if the remaining subcarrier exists as a result of the finding.

7. The method as claimed in claim 6, further comprising:
finding subcarriers within adjacent subcells with a subcell of an area where the relevant antenna is located as the center of the adjacent subcells if no remaining subcarrier exists as a result of the finding; and
borrowing the remaining subcarriers if the remaining subcarriers exist as a result of the finding.

8. The method as claimed in claim 2, wherein, in assigning the found subcarriers, the subcarriers are adaptively assigned, so as to minimize the total transmission power.

9. An apparatus for assigning a subcarrier to a subcell serviced by a Distributed Antenna System (DAS) employing an Orthogonal Frequency Division Multiplexing Access (OFDMA) scheme, the apparatus comprising:
a first assigning unit for:
receiving a fading value of each of multiple antennas located in a same cell,
arranging the received fading values in ascending order, and
selecting antennas in order from an antenna having the minimum fading value among the fading values;
a second assigning unit for:
comparing the transmission power value of the selected antenna with a preset maximum power and quality of a signal, respectively, and
selecting an antenna according to a result of said comparison; and
a third assigning unit for:
finding the remaining subcarriers within adjacent subcells with a relevant subcell where the selected antenna is located or the relevant subcell as the center of the adjacent subcells, and
assigning the found remaining subcarriers in consideration of the total transmission power in a cell.

10. An apparatus for assign a subcarrier in a cell serviced by a Distributed Antenna System (DAS) employing an Orthogonal Frequency Division Multiplexing Access (OFDMA) scheme in a broadband wireless access system, the apparatus comprising:
a process in communication with a memory, the memory containing code, which when accessed by the processor causes the processor to execute:
dividing an overall frequency band into multiple subcarrier bands;
assigning the multiple subcarrier bands to respective Base Stations (BSs) without overlapping among the BSs adjacent to one another in assigning the multiple subcarrier bands to the respective BSs; and
dividing the assigned subcarrier bands and selectively assigning the divided subcarrier bands to multiple Remote Stations (RSs) connected with the BSs through optical fibers.

11. The apparatus as claimed in claim 10, wherein the processor further executing:
measuring a respective fading values of multiple antennas located in the same cell, and assigning the measured fading values in ascending order;
selecting an antenna in an order from a minimum fading value among fading values assigned in ascending order;
comparing the transmission power value of the selected antenna and the preset maximum power and quality of a signal, and determining if an antenna is selected according to a result of the comparison;
finding the remaining subcarriers within adjacent subcells with a relevant subcell where the selected antenna is located or the relevant subcell as the center of the adjacent subcells; and
assigning the found subcarriers in consideration of the total transmission power within the same cell where the subcell is located.

12. The apparatus as claimed in claim 11, wherein the processor further executing:
shutting off a specific Subscriber Station (SS) attempting access in a case where a comparison is made between the number of times by which the selection of the antenna having the minimum fading value is performed and the total number of antennas within the relevant cell, and the number of times is equal to the total number of antennas.

13. The apparatus as claimed in claim 11, wherein the processor further executing:
selecting an antenna having the second rank of the minimum fading value except for the selected antenna if the selected antenna has the preset maximum power and quality of a signal.

14. The apparatus as claimed in claim 11, wherein the processor further executing:
selecting an antenna having the second rank of the minimum fading value except for the selected antenna if the selected antenna has the power and quality of a signal that is greater than the preset maximum power and quality of a signal.

15. The apparatus as claimed in claim 11, wherein the processor further executing:
finding the remaining subcarrier within a subcell of an area where the relevant antenna is located if the selected antenna has the power and quality of a signal that is less than the preset maximum power and quality of a signal; and
assigning power and a subcarrier in consideration of the total transmission power within the same cell where the subcell is located if the remaining subcarrier exists as a result of the finding.

16. The apparatus as claimed in claim 15, wherein the processor further executing:
finding subcarriers within adjacent subcells with a subcell of an area where the relevant antenna is located as the center of the adjacent subcells if no remaining subcarrier exists as a result of the finding; and
borrowing the remaining subcarriers if the remaining subcarriers exist as a result of the finding.

17. The apparatus as claimed in claim 11, wherein, in assigning the found subcarriers, the subcarriers are adaptively assigned, so as to minimize the total transmission power.

18. A base station in wireless communication system serviced by a Distributed Antenna System (DAS) employing an Orthogonal Frequency Division Multiplexing Access (OFDMA) scheme, the base station comprising:
at least one processing module in communication with at least one memory, the at least one memory containing instruction which when accessed by a corresponding one of the at least one processing module causes the at least one processing module to perform:
receiving a fading value of each of multiple antennas located in a same cell,
arranging the received fading values in ascending order,
selecting antennas in order from an antenna having the minimum fading value among the fading values;
comparing the transmission power value of the selected antenna with a preset maximum power and quality of a signal, respectively, and
selecting an antenna according to a result of said comparison;
finding the remaining subcarriers within adjacent subcells with a relevant subcell where the selected antenna is located or the relevant subcell as the center of the adjacent subcells, and
assigning the found remaining subcarriers in consideration of the total transmission power in a cell.
